(19) United States
(12) Patent Application Publication
(10) Pub. No.: US 2024/0118895 A1
(43) Pub. Date: Apr. 11, 2024

(54) AHEAD PREDICTION METHOD AND BRANCH TRACE CACHE FOR DIRECT JUMPING

(71) Applicant: Suzhou Ricore IC Technologies Ltd., Jiangsu Province (CN)

(72) Inventors: Ran ZHANG, Jiangsu Province (CN); Fei WANG, Jiangsu Province (CN)

(21) Appl. No.: 18/565,198

(22) PCT Filed: Aug. 10, 2022
(86) PCT No.: PCT/CN2022/111398

§ 371 Date: Nov. 29, 2023

(30) Foreign Application Priority Data
Sep. 3, 2021 (CN) 202111033727.6

(51) Int. Cl. G06F 9/38; G06F 9/30

(52) U.S. Cl. CPC G06F 9/3808; G06F 9/30047

(57) ABSTRACT

Disclosed in the present invention are an ahead prediction method and branch instruction trace cache for direct jumping. The branch trace cache comprises: a prediction table based on historical branch information, which prediction table is used for implementing two jumping predictions, wherein the prediction table based on the historical branch information comprises the current branch prediction table and an ahead branch trace cache prediction table; a branch trace cache, which comprises a plurality of entries, each entry storing a plurality of consecutive instructions, and the plurality of consecutive instructions including a branch instruction, wherein each entry serves as a branch trace cache item, and comprises: a target instruction of the branch instruction, a sequential address of the target instruction of the branch instruction, a jump address of the target instruction of the branch instruction, and a tag; and a system cache.

### TECHNICAL FIELD

The present disclosure relates to the field of cache processors, in particular to a method for ahead predicting a direct jump and a branch instruction trace cache thereof.

### BACKGROUND

FIG. 1 is an instruction flow of consecutive jumps, as shown in FIG. 1, due to the presence of conditional branch instructions (Instr_0 and Instr_x), two consecutive jumps occur at a processor upon instruction fetch, i.e., a first jump and a second jump, respectively. FIG. 2 is a timing diagram of a prior art processor after encountering consecutive branch instructions (Instr_0, instr_x and Instr_t). As shown in FIG. 2, the prior art branch instructions (Instr_0, instr_x and Instr_t) introduce bubbles, i.e. pipeline bubbles (i.e. the pause time of the processor), into the pipeline of the processor, wherein the introduced pipeline bubbles are composed of two parts, i.e. the bubbles introduced by a jump prediction and the bubbles introduced by address redirection, respectively, and the introduced two parts of the pipeline bubbles reduce the performance and cache usage efficiency of the processor.

At present, conventional branch target instruction trace cache (Branch Trace Cache, BTC) approaches are commonly used in the art to mitigate pipeline bubbles to improve a processor's performance. FIG. 3 is a timing diagram after encountering consecutive branch instructions subsequently to using a conventional BTC post-processor. As shown in FIG. 3, a conventional branch target instruction trace cache (BTC) places a target instruction of a branch jump into a cache, and when a conditional branch instruction (Instr_0) hits the branch target instruction trace cache (BTC), the required instruction can be quickly read from the branch target instruction trace cache (BTC); therefore, pipeline bubbles introduced by address redirection can be alleviated in the manner of a conventional BTC. However, current designs do not achieve an ahead prediction of branch instructions in the branch target instruction trace cache (BTC), and do not eliminate the pipeline bubbles introduced by branch instructions. Therefore, the traditional BTC approach is still not able to handle the consecutive jump instruction stream well, and has limited ability to improve processor performance.

### SUMMARY

In order to solve the above problems, the present disclosure provides a method for ahead predicting a direct jump and a branch instruction trace cache thereof, by using an ahead predictable branch instruction trace cache (APBTC) to store a target instruction which is directly jumped to so that a required instruction can be quickly fetched when the ahead predictable branch instruction trace cache (APBTC) is hit, thereby eliminating the pipeline bubbles introduced by branch instructions. In addition, the ahead branch prediction mechanism provided by the present disclosure can predict branch instructions within ahead predictable branch instruction trace cache (APBTC) entries, thereby reducing the pipeline bubbles caused by consecutive jumps, improving processor performance and utilization efficiency, and reducing power consumption.

In order to achieve the above object, the present disclosure provides a method for ahead predicting a direct jump, including the steps of:
step 1: accessing a prediction table based on branch history information and a branch target instruction trace cache in a first level pipeline stage, wherein the prediction table based on the branch history information includes a current branch prediction table and an ahead branch instruction trace cache prediction table; and
fetching contents of the ahead branch instruction trace cache prediction table and a branch target instruction trace cache and instructions in a system cache in a second level pipeline stage;
step 2: determining whether a current instruction of the instructions fetched from a system cache is a branch instruction;
if the current instruction is not a branch instruction, sequentially fetching instructions in order;
if the current instruction is a branch instruction, then proceeding to step 3;
step 3: determining whether the fetched current branch instruction hits a branch target instruction trace cache;
if not hitting, taking a jumping address of the branch instruction as a next instruction-fetching address, and establishing a corresponding ahead predictable branch instruction trace cache entry;
if hitting, proceeding to step 4;
step 4: fetching a next instruction to be executed directly from the branch target instruction trace cache, and predicting a jump of the next instruction to be executed according to the ahead branch instruction trace cache prediction table;

If the next instruction to be executed is a branch instruction and a jump is predicted, taking a jumping address of a target instruction of the branch instruction stored in the branch target instruction trace cache as a next instruction-fetching address;

If the next instruction to be executed is not a branch instruction or a jump is not predicted, taking a sequential address of the target instruction of the branch instruction stored in the branch target instruction trace cache as the next instruction-fetching address.

In an embodiment of the present disclosure, wherein in step 3, determining whether the branch target instruction hits the branch instruction trace cache further comprises:
determining whether the branch instruction matches a corresponding tag in the branch target instruction trace cache; and if matching, the branch target instruction trace cache is hit; if not matching, the branch target instruction trace cache is not hit.

To achieve the above object, the present disclosure also provides a branch instruction trace cache for ahead predicting a direct jump, including:
a prediction table based on branch history information for achieving two-jump predictions, wherein the prediction table based on the branch history information includes a current branch prediction table and an ahead branch instruction trace cache prediction table;
a branch target instruction trace cache including a plurality of entries, each entry storing a plurality of consecutive instructions containing a branch instruction, wherein each entry as a branch target instruction trace cache entry includes: a target instruction of the branch instruction, a sequential address of the target instruction of the branch instruction, a jumping address of the target instruction of the branch instruction and a tag; and
a system cache; wherein
when in the first level pipeline stage, the system simultaneously accesses the branch target instruction trace cache, the current branch prediction table, and the ahead branch instruction trace cache prediction table via a current instruction address, and if the current branch prediction table predicts that the instruction does not jump, then the processor sequentially fetches instructions in order in the second level pipeline stage;
if the current branch prediction table predicts an instruction jump and the branch target instruction trace cache is hit, the processor fetches a next instruction to be executed from the branch target instruction trace cache in a second level pipeline stage; at the same time, the ahead branch instruction trace cache prediction table predicts an instruction stored in the branch target instruction trace cache, and if a jump is predicted, a next instruction-fetching source is a jumping address of a target instruction of the branch instruction; if a jump is not predicted, the instruction-fetching source is the sequential address of the target instruction of the branch instruction.

Compared with the prior art, the ahead predictable branch instruction trace cache (APBTC) of the present disclosure is used for storing a target instruction for a direct jump, and when the ahead predictable branch instruction trace cache (APBTC) is hit, a required instruction can be quickly fetched, thereby eliminating pipeline bubbles introduced by a branch instruction; in addition, the present disclosure proposes that a method for ahead prediction based on branch history information can predict whether an instruction in a branch target instruction trace cache (BTC) jumps, thereby filling bubbles introduced by instruction jump prediction.

### BRIEF DESCRIPTION OF THE DRAWINGS

In order to explain the embodiments of the present disclosure or the technical solutions in the prior art more clearly, a brief description will be given below with reference to the accompanying drawings which are used in the description of the embodiments or the prior art, and it is obvious that the drawings in the description below are merely some embodiments of the present disclosure, and it would have been obvious for a person skilled in the art to obtain other drawings according to these drawings without involving any inventive effort.

FIG. 1 is an instruction stream for consecutive jumps;

FIG. 2 is a timing diagram of a prior art processor after encountering a sequential branch instruction;

FIG. 3 is a timing diagram after encountering consecutive branch instructions subsequently to using a conventional BTC post-processor;

FIG. 4 is a flowchart of a method for ahead prediction according to an embodiment of the present disclosure;

FIG. 5 is a timing diagram after processing by the method according to an embodiment of the present disclosure;

FIG. 6 is an architectural diagram of an ahead predictable branch instruction trace cache according to an embodiment of the present disclosure.

Description of reference numerals: 10—prediction table based on branch history information; 101—current branch prediction table; 102—ahead branch instruction trace cache prediction table; 20—branch target instruction trace cache; 201—sequential address of the target instruction of the branch instruction; 202—jumping address of the target instruction of the branch instruction; 203—target instruction of the branch instruction; 204—tag; 30—system cache; F1—first level pipeline; F2—second level pipeline.

### DETAILED DESCRIPTION

The embodiments of the present disclosure will now be described more fully hereinafter with reference to the accompanying drawings, in which embodiments of the present disclosure are shown. It is to be understood that the embodiments described are only a few, but not all embodiments of the present disclosure. Based on the embodiments of the present disclosure, all other embodiments obtained by a person skilled in the art without inventive effort fall within the scope of the present disclosure.

### Embodiment I

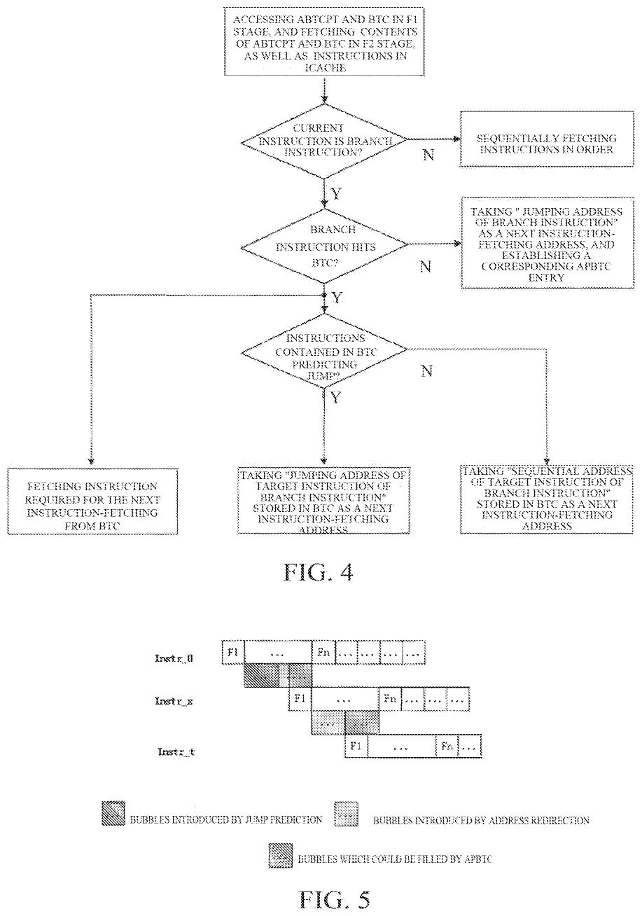

FIG. 4 is a flowchart of a method for ahead prediction according to an embodiment of the present disclosure. As shown in FIG. 4, this embodiment provides a method for ahead predicting a direct jump, including the steps of:
Step 1: accessing a prediction table based on branch history information and a branch target instruction trace cache (BTC) in a first level pipeline (F1) stage, wherein the prediction table based on branch history information includes a current branch prediction table and an ahead branch instruction trace cache prediction table (ahead branch trace cache prediction table, ABTCPT); and
fetching contents of an ahead branch instruction trace cache prediction table (ABTCPT) and a branch target instruction trace cache (BTC) and instructions in a system cache (ICache) in a second level pipeline (F2) stage;
Step 2: determining whether a current instruction of the instructions fetched from a system cache (ICache) is a branch instruction;
if the current instruction is not a branch instruction, sequentially fetching instructions in order, without processing the contents of the ahead branch instruction trace cache prediction table (ABTCPT) and the branch target instruction trace cache (BTC);
if the current instruction is a branch instruction, then proceeding to step 3;
step 3: determining whether the fetched current branch instruction hits a branch target instruction trace cache (BTC);
if not hitting, taking a jumping address of the branch instruction as a next instruction-fetching address, and establishing a corresponding ahead predictable branch instruction trace cache (APBTC) entry;
if hitting, proceeding to step 4.

In this embodiment, in step 3, determining whether the branch instruction hits the branch target instruction trace cache (BTC) further comprises:
determining whether the branch instruction matches a corresponding tag (Tag) in the branch target instruction trace cache (BTC); and if matching, the branch target instruction trace cache (BTC) is hit; if not matching, the branch target instruction trace cache (BTC) is not hit.
Step 4: fetching a next instruction to be executed directly from the branch target instruction trace cache (BTC), and predicting a jump of the next instruction to be executed according to the ahead branch instruction trace cache prediction table (ahead branch trace cache prediction table, ABTCPT);

If the next instruction to be executed is a branch instruction and a jump is predicted, taking a jumping address of a target instruction of the branch instruction stored in the branch target instruction trace cache (BTC) as a next instruction-fetching address;

If the next instruction to be executed is not a branch instruction or a jump is not predicted, taking a sequential address of the target instruction of the branch instruction stored in the branch target instruction trace cache (BTC) as the next instruction-fetching address.

The method for ahead predicting a direct jump of this embodiment is a method for processing branch history information capable of simultaneously predicting whether a jump occurs in a direct jump instruction and predicting whether a jump occurs in an instruction in a BTC. The ahead branch instruction trace cache prediction table (ABTCPT) and branch target instruction trace cache (BTC) are accessed in the first level pipeline because: 1) obtaining an instruction following a direct jump instruction from a branch target instruction trace cache (BTC); 2) the branch target instruction trace cache (BTC) includes a jumping address of an instruction of the branch target instruction trace cache (BTC); 3) it can be predicted whether an instruction in the branch target instruction trace cache (BTC) will jump, and therefore, the method for this embodiment can effectively resolve the bubbles produced from consecutive jumps of instructions.

FIG. 5 is a timing diagram after processing by the method according to an embodiment of the present disclosure. As shown in FIG. 5, the method for this embodiment can first fill the bubbles introduced by address redirection as in the conventional BTC, i.e., the part that can be predicted by the current branch prediction table. When a jump instruction occurs, such as a first jump instruction (Instr_0), the bubbles introduced by the jump prediction will occur; however, the method (APBTC) implemented in the present disclosure can realize ahead prediction, and can predict whether the next jump instruction is a jump instruction; if the next jump instruction is a jump instruction (Instr_x), the jumping address thereof can be directly fetched; therefore, the bubbles introduced by the jump prediction can be filled, therefore it is equivalent to realizing two-level prediction (+2 prediction).

### Embodiment II

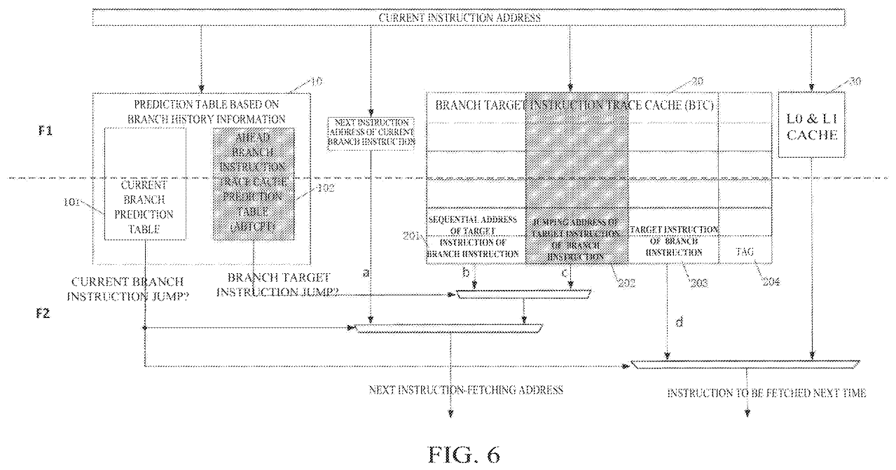

FIG. 6 is an architecture diagram of an ahead predictable branch instruction trace cache according to an embodiment of the present disclosure. As shown in FIG. 6, this embodiment provides an ahead predictable branch instruction trace cache (APBTC) for a direct jump, for executing the method in embodiment 1, including:

A prediction table (10) based on branch history information for realizing two jump predictions, wherein the prediction table (10) based on branch history information includes a current branch prediction table (101) and an ahead branch instruction trace cache prediction table (ABTCPT) (102); a current branch prediction table (101) is adapted to predict whether the next one instruction is a jump instruction, and an ahead branch instruction trace cache prediction table (ABTCPT) (102) is adapted to predict whether the next two instructions are jump instructions.

A branch target instruction trace cache (BTC) (20) including a plurality of entries, each entry storing a plurality of consecutive instructions containing a branch instruction, wherein each entry as a branch target instruction trace cache entry includes: a target instruction (203) of the branch instruction, a sequential address (201) of the target instruction of the branch instruction, a jumping address (202) of the target instruction of the branch instruction and a tag (Tag) (204);

As shown in FIG. 6, it is assumed that the branch target instruction trace cache (BTC) (20) includes N instructions per entry. As the BTC in the prior art, the sequential addresses of the N instructions can be stored in one entry. However, in a typical design, the N instructions of the BTC cannot contain a branch instruction, and the N instructions of the BTC will be truncated if a branch is encountered. In this embodiment, since N can be predicted ahead, the inclusion of a branch instruction is allowed, i.e., if N instructions include a jump instruction, a jumping address of the branch also needs to be stored.

A system cache (L0 & L1 Cache) (30); wherein, the system cache (L0 & L1 Cache) (30) is a processor general cache, which will not be described in detail herein.

When in a first level pipeline (F1) stage, the system simultaneously accesses a branch target instruction trace cache (BTC) (20), a current branch prediction table (101) and an ahead branch instruction trace cache prediction table (ABTCPT) (102) via a current instruction address, and if the current branch prediction table (101) predicts that an instruction does not jump, the processor sequentially fetches instructions (as a in FIG. 6) in order in a second level pipeline (F2) stage, i.e., fetching instructions in an instruction order;
if the current branch prediction table (101) predicts an instruction jump and the branch target instruction trace cache (BTC) (20) is hit, then the processor fetches a next instruction to be executed from the branch target instruction trace cache (BTC) (20) in the second level pipeline (F2) stage; at the same time, an instruction stored in the branch target instruction trace cache (BTC) (20) is predicted by the ahead branch instruction trace cache prediction table (ABTCPT) (102); if a jump is predicted, the next instruction-fetching source is a jumping address (202) (as c in FIG. 6) of the target instruction of the branch instruction; if a jump is not predicted, the instruction-fetching source is the sequential address (201) (as b in FIG. 6) of the target instruction of the branch instruction, thereby achieving ahead prediction (+2 prediction).

### Embodiment III

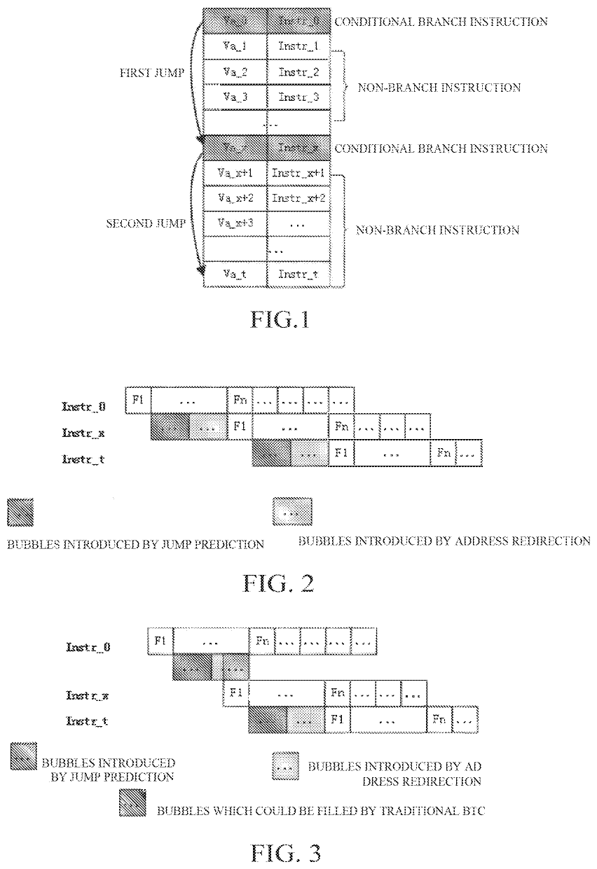

Referring again to FIG. 1 and FIG. 6, the two-level prediction (+2 prediction) of the ahead predictable branch instruction trace cache (APBTC) is illustrated as follows:
before the first jump, a common branch predictor is indexing with Va_0 so as to obtain a prediction result of Instr_0;
before the first jump, the ahead predictable branch instruction trace cache (APBTC) of this embodiment can simultaneously obtain the prediction results of the conditional branch instruction Instr_0 of the first jump and the conditional branch instruction Instr_x of the second jump by indexing with Va_0. That is, the current branch prediction table provides Instr_0; and the ABTCPT provides Instr_x, so as to realize ahead prediction. Therefore, the bubbles introduced by the current branch redirection are reduced; and the bubbles introduced by the second branch jump prediction are reduced too. Therefore, the ahead predictable branch instruction trace cache (APBTC) of this embodiment can provide higher performance for a processor.

The ahead predictable branch instruction trace cache (APBTC) of the present disclosure is adapted to store a target instruction for a direct jump. And when the ahead predictable branch instruction trace cache (APBTC) is hit, a required instruction can be quickly fetched, thereby eliminating pipeline bubbles introduced by a branch instruction. In addition, the present disclosure proposes that a method for ahead prediction based on branch history information can predict whether an instruction in a branch target instruction trace cache (BTC) jumps, thereby filling bubbles introduced by instruction jump prediction.

A person skilled in the art will appreciate that the figures are merely schematic illustrations of an embodiment, and the blocks or flows in the figures are not necessarily required to practice the present disclosure.

A person skilled in the art will appreciate that modules in an apparatus in an embodiment may be distributed throughout an apparatus in an embodiment as described in the embodiment, or may be varied accordingly in one or more apparatuses other than this embodiment. The modules of the above embodiments may be combined into one module or further split into a plurality of sub-modules.

Finally, it should be noted that: the above embodiments are only used to illustrate the technical solution of the present disclosure, and not to limit the same; while the present disclosure has been described in detail and with reference to the foregoing embodiments, it will be understood by a person skilled in the art that: the technical solutions described in the foregoing embodiments may still be modified, or some technical features may be equivalently replaced; and these modifications or substitutions do not depart from the spirit and scope of the corresponding technical solutions of the embodiments of the present disclosure.

1. A method for ahead predicting a direct jump, comprising the steps of:
step 1: accessing a prediction table based on branch history information and a branch target instruction trace cache in a first level pipeline stage, wherein the prediction table based on the branch history information comprises a current branch prediction table and an ahead branch instruction trace cache prediction table; and
fetching contents of the ahead branch instruction trace cache prediction table and a branch target instruction trace cache and instructions in a system cache in a second level pipeline stage;
step 2: determining whether a current instruction of the instructions fetched from a system cache is a branch instruction;
if the current instruction is not a branch instruction, sequentially fetching instructions in order;
if the current instruction is a branch instruction, then proceeding to step 3;
step 3: determining whether the fetched current branch instruction hits a branch target instruction trace cache;
if not hitting, taking a jumping address of the branch instruction as a next instruction-fetching address, and establishing a corresponding ahead predictable branch instruction trace cache entry;
if hitting, proceeding to step 4;
step 4: fetching a next instruction to be executed directly from the branch target instruction trace cache, and predicting a jump of the next instruction to be executed according to the ahead branch instruction trace cache prediction table;
if the next instruction to be executed is a branch instruction and a jump is predicted, taking a jumping address of a target instruction of the branch instruction stored in the branch target instruction trace cache as a next instruction-fetching address;
if the next instruction to be executed is not a branch instruction or a jump is not predicted, taking a sequential address of the target instruction of the branch instruction stored in the branch target instruction trace cache as the next instruction-fetching address.

2. The method according to claim 1, wherein in step 3, determining whether the branch target instruction hits the branch instruction trace cache further comprises:
determining whether the branch instruction matches a corresponding tag in the branch target instruction trace cache; and if matching, the branch target instruction trace cache is hit; if not matching, the branch target instruction trace cache is not hit.

3. A branch instruction trace cache for ahead predicting a direct jump, comprising:
a prediction table based on branch history information for achieving two-jump predictions, wherein the prediction table based on the branch history information comprises a current branch prediction table and an ahead branch instruction trace cache prediction table;
a branch target instruction trace cache comprising a plurality of entries, each entry storing a plurality of consecutive instructions containing a branch instruction, wherein each entry as a branch target instruction trace cache entry comprises: a target instruction of the branch instruction, a sequential address of the target instruction of the branch instruction, a jumping address of the target instruction of the branch instruction and a tag; and
a system cache; wherein
when in the first level pipeline stage, the system simultaneously accesses the branch target instruction trace cache, the current branch prediction table, and the ahead branch instruction trace cache prediction table via a current instruction address, and if the current branch prediction table predicts that the instruction does not jump, then the processor sequentially fetches instructions in order in the second level pipeline stage;
if the current branch prediction table predicts an instruction jump and the branch target instruction trace cache is hit, the processor fetches a next instruction to be executed from the branch target instruction trace cache in a second level pipeline stage; at the same time, the ahead branch instruction trace cache prediction table predicts an instruction stored in the branch target instruction trace cache, and if a jump is predicted, a next instruction-fetching source is a jumping address of a target instruction of the branch instruction; if a jump is not predicted, the instruction-fetching source is the sequential address of the target instruction of the branch instruction.
